(19) United States
(12) Patent Application Publication
(10) Pub. No.: US 2026/0337084 A1
(43) Pub. Date: Oct. 29, 2026

(54) ELECTRIC GLASS MELTING FURNACES

(71) Applicant: KNAUF INSULATION, INC., Shelbyville, IN (US)

(72) Inventors: Andrew J. Purvis, Carmel, IN (US); Michael L. Strange, Marshall, MI (US); Himanshu Bhatta, Apex, NC (US); Brandon J. Sink, Hedgesville, WV (US); Mark P. Fieldsend, Lutz, FL (US)

(21) Appl. No.: 19/556,928

(22) Filed: Mar. 4, 2026

Related U.S. Application Data
(60) Provisional application No. 63/793,163, filed on Apr. 23, 2025.

(51) Int. Cl. C03B 5/435; C03B 5/03; F27B 3/08; F27D 1/00; F27D 1/14

(52) U.S. Cl. CPC C03B 5/435; C03B 5/03; F27B 3/08; F27D 1/0043; F27D 1/141; F27D 2001/0063

(57) ABSTRACT

A furnace system for electric melting of glass includes a melting chamber bounded by a hearth and a perimeter wall including a first plurality of refractory liner blocks extending upward from the hearth and forming a perimeter of the melting chamber, and a plurality of overcoat refractory blocks facing the plurality of refractory liner blocks. A plurality of electrode islands including a plurality of electrodes extend through the hearth into the melting chamber. A modular bracing network surrounds the plurality of overcoat refractory blocks and reinforcing the perimeter wall and including a plurality of struts and a plurality of fasteners coupling respective ones of the plurality of struts, each of the plurality of struts being individually removeable from the network by manipulation of a subset of the plurality of fasteners.

### CROSS-REFERENCE

The present disclosure claims priority to and the benefit of U.S. Application No. 63/793,163 filed Apr. 23, 2025, and the same is hereby incorporated by reference.

### BACKGROUND

The present disclosure relates to electric glass melting furnaces and to related apparatuses, systems, and processes. Conventional electric glass melting furnaces suffer from a number of drawbacks, disadvantages, and shortcomings including those respecting service life, serviceability, repairability, and others. There remains a significant need for the unique apparatuses, systems, and processes disclosed herein.

### DISCLOSURE OF EXAMPLE EMBODIMENTS

For the purposes of clearly, concisely, and exactly describing example embodiments of the present disclosure, the manner, and process of making and using the same, and to enable the practice, making and use of the same, reference will now be made to certain example embodiments, including those illustrated in the figures, and specific language will be used to describe the same. It shall nevertheless be understood that no limitation of the scope of the invention is thereby created, and that the invention as set forth in the claims following this disclosure includes and protects such alterations, modifications, and further applications of the example embodiments as would occur to one skilled in the art with the benefit of the present disclosure.

### SUMMARY OF THE DISCLOSURE

Some embodiments comprise unique electric glass melting furnace apparatuses. Some embodiments comprise unique electric glass melting furnace systems. Some embodiments comprise unique electric glass melting furnace processes. Further embodiments, forms, objects, features, advantages, aspects, and benefits shall become apparent from the following description and drawings.

### BRIEF DESCRIPTION OF THE DRAWINGS

FIG. 1 is a top view depicting certain aspects of an example electric glass melting furnace system containing glass.

FIG. 2 is a top view depicting certain aspects of the example electric glass melting furnace system of FIG. 1 emptied of glass.

FIG. 3 is a top view depicting certain aspects of an electrode system of the example electric glass melting furnace system of FIG. 1.

FIG. 4 is a top view depicting certain aspects of a portion of an example embodiment of the example electric glass melting furnace system of FIG. 1 in a first configuration.

FIG. 5 is a side view depicting certain aspects of a portion of an example embodiment of the example electric glass melting furnace system of FIG. 1 in a first configuration.

FIG. 6 is a top view depicting certain aspects of a portion of an example embodiment of the example electric glass melting furnace system of FIG. 1 in a second configuration.

FIG. 7 is a side view depicting certain aspects of a portion of an example embodiment of the example electric glass melting furnace system of FIG. 1 in a second configuration.

FIG. 8 is a top view depicting certain aspects of a portion of an example embodiment of the example electric glass melting furnace system of FIG. 1 in a third configuration.

FIG. 9 is a side view depicting certain aspects of a portion of an example embodiment of the example electric glass melting furnace system of FIG. 1 in a third configuration.

FIG. 10 is a top view depicting certain aspects of a portion of an example embodiment of the example electric glass melting furnace system of FIG. 1 in a fourth configuration.

FIG. 11 is a side view depicting certain aspects of a portion of an example embodiment of the example electric glass melting furnace system of FIG. 1 in a fourth configuration.

FIG. 12 is a top view depicting certain aspects of a portion of an example embodiment of the example electric glass melting furnace system of FIG. 1 in a fifth configuration.

FIG. 13 is a side view depicting certain aspects of a portion of an example embodiment of the example electric glass melting furnace system of FIG. 1 in a fifth configuration.

### DETAILED DESCRIPTION OF EXAMPLE EMBODIMENTS

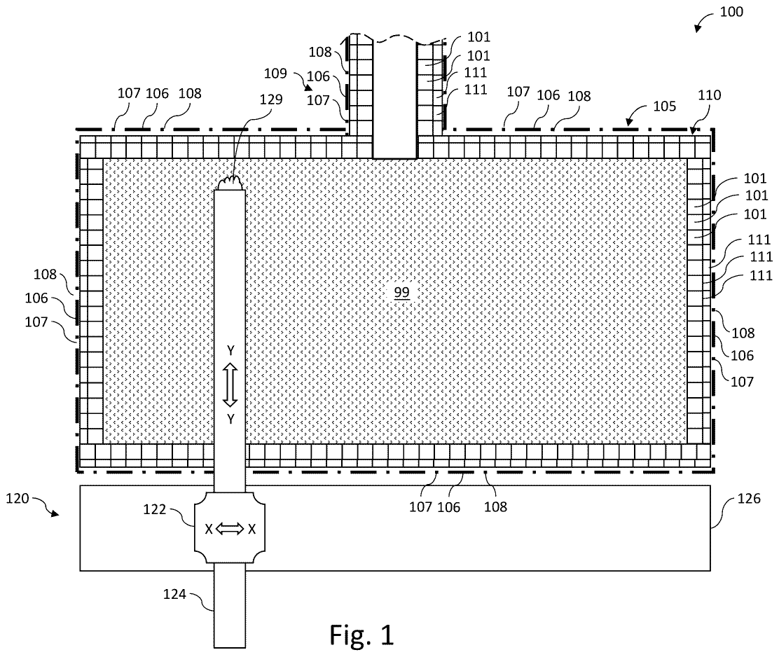

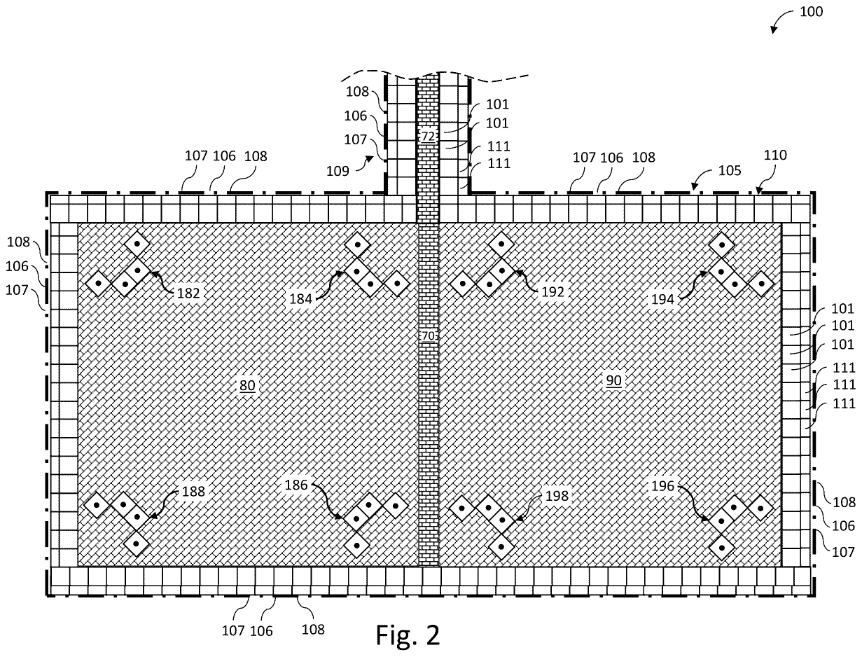

Referring now to the drawings and with initial reference to FIGS. 1 and 2, there is illustrated an example electric glass melting furnace system 100 (also referred to herein as system 100) which is configured and operable to electrically melt a glass batch mixture 129 which is introduced into melting furnace system by conveyor system 120. In the illustrated example, conveyor system 120 includes a conveyor boom 124 which is configured to transport glass batch mixture 129 to an output of conveyor boom 124 via which the glass batch mixture is introduced into system 100.

Glass batch mixture 129 is received at and supplied to conveyor boom 124 by hopper 122 which may be loaded by various feedstream conveyance mechanisms (not illustrated). The feedstream inputs to and constituents of glass batch mixture 129 may include recycled, broken, or waste glass (also referred to as cullet), as well as sand, limestone, soda ash, boron materials (e.g., borax or boron trioxide B2O3), and/or other constituents as will occur to one of skill in the art with the benefit and insight of the present disclosure. It shall be appreciated that the ratio of cullet in the overall batch mixture may reduce the energy required to melt the overall batch mixture into flowable glass.

Conveyor boom 124 is extensible and retractable relative to a hopper 122 in a direction generally indicated by arrow Y-Y. Hopper 122 is moveable along pier 126 in a direction generally indicated by arrow X-X. Via a combination of the aforementioned movement of boom 124 and hopper 122, conveyor system 120 is configured and operable to distribute glass batch mixture 129 across an upper surface of melt glass 99 which contained and melted by electrical heating elements of system 100. In the illustrated example, upper surface of melt glass 99 is a so-called cold-top comprising a layer of unmelted glass batch mixture on top of melted glass.

System 100 comprises a melting chamber which is bounded on its sides by a perimeter wall 110 and is bounded on its bottom by a hearth comprising hearth region 80, hearth region 90, and hearth region 70 which are configured and provided with a generally rectangular geometry.

Perimeter wall 110 comprises a plurality of refractory liner blocks 101 and a plurality of overcoat refractory blocks 111. It shall be appreciated that only several of the plurality of refractory liner blocks 101 and only several of the plurality of overcoat refractory blocks 111 are labeled with reference numerals to preserve clarity of illustration. The plurality of refractory liner blocks 101 extend upward from hearth 80 and form an inner perimeter lining the melting chamber and containing and exposed to melt glass 99. The plurality of overcoat refractory blocks 111 extend upward from the hearth 80 and face the plurality of refractory liner blocks 101.

It shall be appreciated that the thicknesses of the plurality of refractory liner blocks 101 and the plurality of overcoat refractory blocks 111 are selected and configured to provide a balance or optimization between insulation of melt glass 99 to promote thermal efficiency and cooling of perimeter wall 110 to mitigate degradation of the plurality of refractory liner blocks exposed to melt glass 99. It shall be further appreciated that the thicknesses of the plurality of overcoat refractory blocks 111 are selected and configured to provide the ability to add additional layers of overcoat refractory blocks about the overcoat refractory blocks 111 illustrated in FIGS. 1 and 2, and preferably multiple layers of such supplemental overcoat refractory blocks to maximize the service life of a given instantiation of perimeter wall 110 as augmented by such addition.

System 100 further includes an outlet throat region 109 of perimeter wall 110 which includes an outlet hearth region 72 bounded by some of the plurality of refractory liner blocks 101 and some of the plurality of overcoat refractory blocks 111. Outlet throat region 109 is configured and operable to provide a flow of melted glass to one or more glass processing systems, for example, a fiberglass spinner system.

A modular bracing network 105 surrounds the plurality of overcoat refractory blocks 111 and reinforces perimeter wall 110. The modular bracing network 105 generally includes a plurality of struts 106, a plurality of fasteners 107, and a plurality of posts 108 which are illustrated schematically in FIGS. 1 and 2. To preserve clarity of illustration only some of the plurality of struts 106, only some of the plurality of fasteners 107, and only some of the plurality of posts 108 are labeled with reference numerals in FIGS. 1 and 2. It shall be appreciated that modular bracing network 105 is an example of a modular bracing network including a plurality of structural bracing components or sections which can be selectably coupled and decoupled, combined, interchanged, substituted, and/or replaced to alter and adapt an overall network or system providing structural support for a perimeter wall such as perimeter wall 110 and which may in some cases include components or sections which are generally interchangeable, standardized, repeating, and/or uniform.

The plurality of fasteners 107 couple respective ones of the plurality of struts 106. Each of the plurality of struts 106 is individually removeable from the modular bracing network 105 by manipulation of a subset of the plurality of fasteners 107. The plurality of posts 108 further brace and support the plurality of struts 106 and are removably received by respective substrate anchors (not illustrated in FIGS. 1 and 2). To accommodate addition of additional layers of additional layers of overcoat refractory blocks about the overcoat refractory blocks 111 the plurality of posts 108 are selectably removeable from their respective substrate anchors and repositionable in other substrate anchors positioned farther from perimeter wall 110.

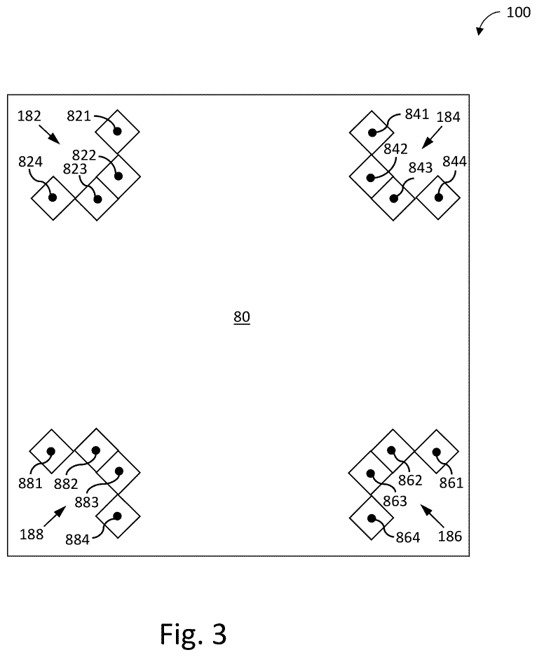

As illustrated in FIGS. 2 and 3, system 100 includes a plurality of electrode islands 182, 184, 186, 188, 192, 194, 196, 198 each comprising a plurality of electrodes extending upward through hearth 80 into the melting chamber bounded by perimeter wall 110. In the illustrated example, electrode islands 182, 184, 186, 188 are provided in hearth region 80 and the plurality of electrode islands 192, 194, 196, 198 are provided in hearth region 90.

In the illustrated embodiment, each of electrode islands 182, 184, 186, 188, 192, 194, 196, 198 comprises four electrodes. As illustrated in FIG. 3, electrode island 182 comprises electrode 821, electrode 822, electrode 823, and electrode 824 which are arranged in a partially offset or staggered relationship diagonally facing electrode island 186 and configured to dia. Electrode Island 184 comprises electrode 841, electrode 842, electrode 843, and electrode 844 which are arranged in a partially offset or staggered relationship diagonally facing electrode island 188. Electrode island 186 comprises electrode 861, electrode 862, electrode 863, and electrode 864 which are arranged in a partially offset or staggered relationship diagonally facing electrode island 182. Electrode island 188 comprises electrode 881, electrode 882, electrode 883, and electrode 884 which are arranged in a partially offset or staggered relationship diagonally facing electrode island 184.

While the electrode islands of the illustrated example each comprise four electrodes, it shall be appreciated that other embodiments contemplated electrode islands with greater or lesser numbers of electrodes. For some applications the use of at least four electrodes may be preferable over lesser numbers of electrodes to provide reduced power and current loads per electrode resulting in lower operating temperatures which can help mitigate corrosion of refractory material contacting or proximate the electrodes.

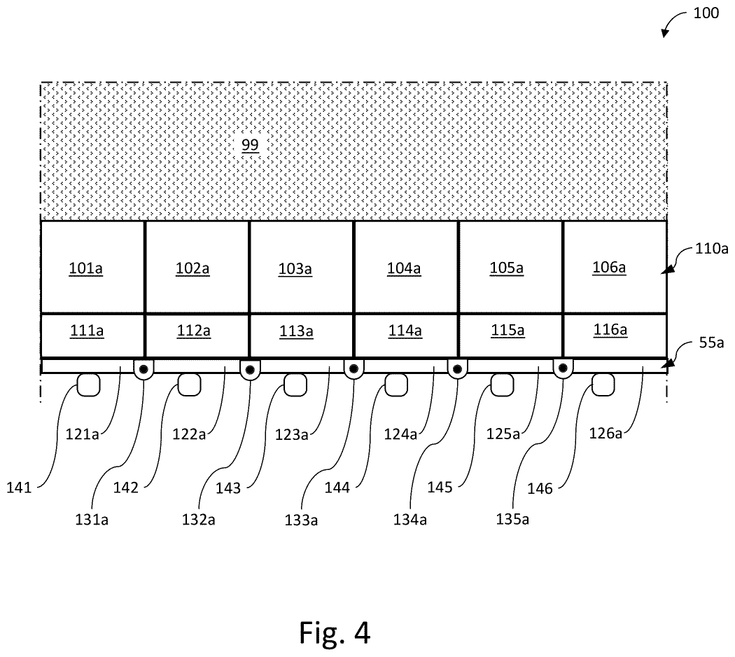

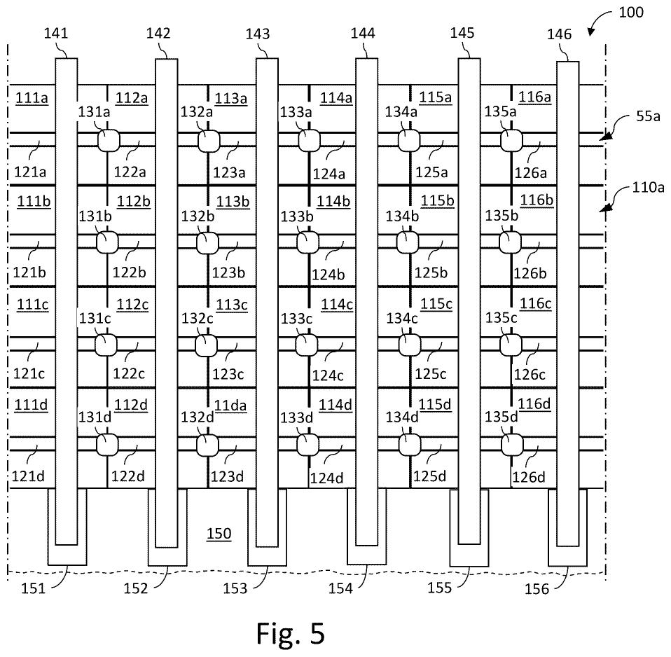

With reference to FIGS. 4 and 5, there is illustrated a portion 110a of perimeter wall 110 and a portion 55a of modular bracing network 105. Portion 110a of perimeter wall 110 includes refractory liner blocks 101a, 102a, 103a, 104a, 105a, 106a as well additional underlying refractory blocks. Portion 110a of perimeter wall 110 further includes overcoat refractory blocks 111a, 112a, 113a, 114a, 115a, 116a which are positioned above underlying refractory blocks 111b, 112b, 113b, 114b, 115b, 116b, underlying refractory blocks 111c, 112c, 113c, 114c, 115c, 116c, and underlying refractory blocks 111d, 112d, 113d, 114d, 115d, 116d.

Portion 55a of modular bracing network 105 includes a row of struts 121a, 122a, 123a, 124a, 125a, 126a adjacent pairs of which are selectably coupled with one another by respective ones of fasteners 131a, 132a, 133a, 134a, 135a. Another row of struts 121b, 122b, 123b, 124b, 125b, 126b adjacent pairs of which are selectably coupled with one another by respective ones of fasteners 131b, 132b, 133b, 134b, 135b. Another row of struts 121c, 122c, 123c, 124c, 125c, 126c adjacent pairs of which are selectably coupled with one another by respective ones of fasteners 131c, 132c, 133c, 134c, 135c. Another row of struts 121d, 122d, 123d, 124d, 125d, 126d adjacent pairs of which are selectably coupled with one another by respective ones of fasteners 131d, 132d, 133d, 134d, 135d.

Portion 55a of modular bracing network 105 includes posts 141, 142, 143, 144, 145, 146 which are inserted into and extend upward from substrate anchors 151, 152, 153, 154, 155, 156. Anchors 151, 152, 153, 154, 155, 156 are provided in substrate 150, for example, in the form of reinforced receptacles or other anchor structures as will occur to one of skill in the art with the benefit and insight of the present disclosure. Posts 141, 142, 143, 144, 145, 146 are selectably removeable from their respective substrate anchors 151, 152, 153, 154, 155, 156, for example during operations to add additional layers of overcoat refractory blocks about the illustrated overcoat refractory blocks.

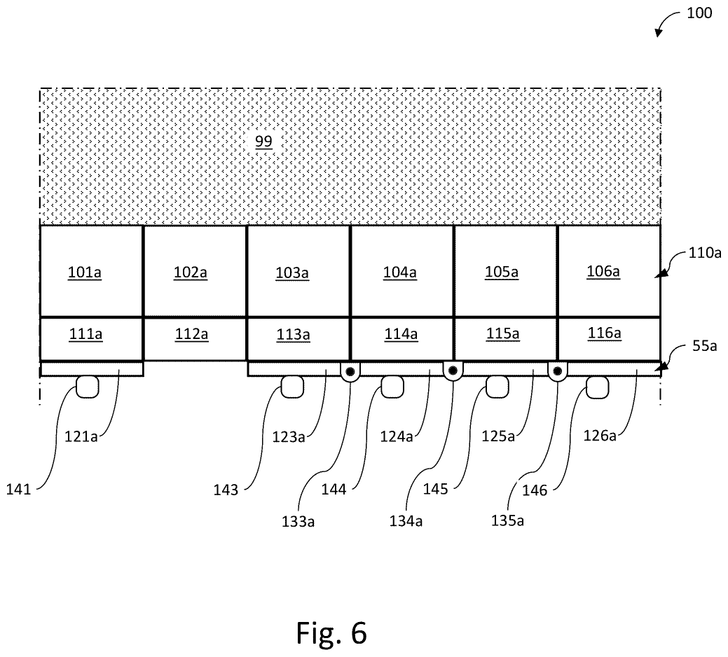

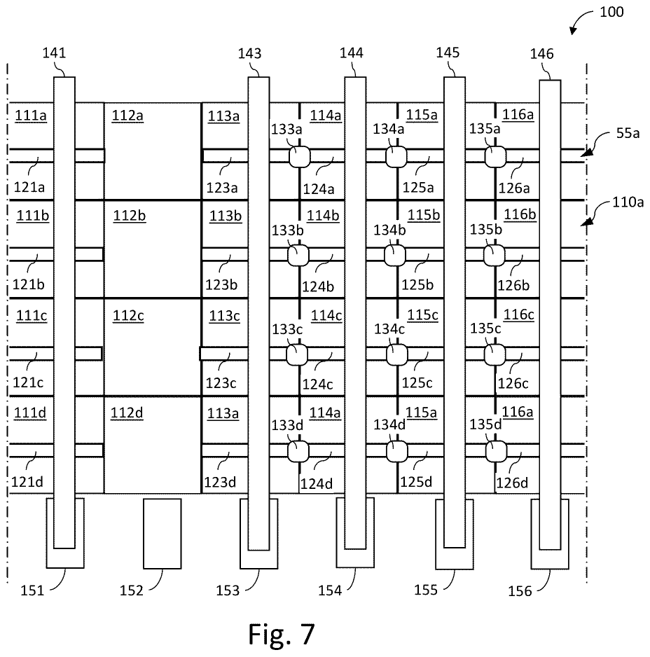

With reference to FIGS. 6 and 7, there is illustrated a portion 110a of perimeter wall 110 and a portion 55a of modular bracing network 105 at a state during an operation to add additional layers of overcoat refractory blocks. In the illustrated state, post 142 has been removed from substrate anchor 152. Furthermore, fasteners 131a-131d have been removed to temporarily decouple struts 121a and 122a, 121b and 122b, 121c and 122c, and 121d and 122d, respectively. Similarly, Furthermore, fasteners 131a-131d have been removed to temporarily decouple struts 122a and 123a, 122b and 123b, 122c and 123c, and 122d and 123d, respectively. Additionally, struts 122a, 122b, 122c, and 122d have been temporarily removed to provide access to overcoat refractory blocks 112a, 112b, 112c, and 112d. Additionally, in the illustrated state, temporary bracing (not illustrated) may be utilized to reinforce overcoat refractory blocks 112a, 112b, 112c, and 112d.

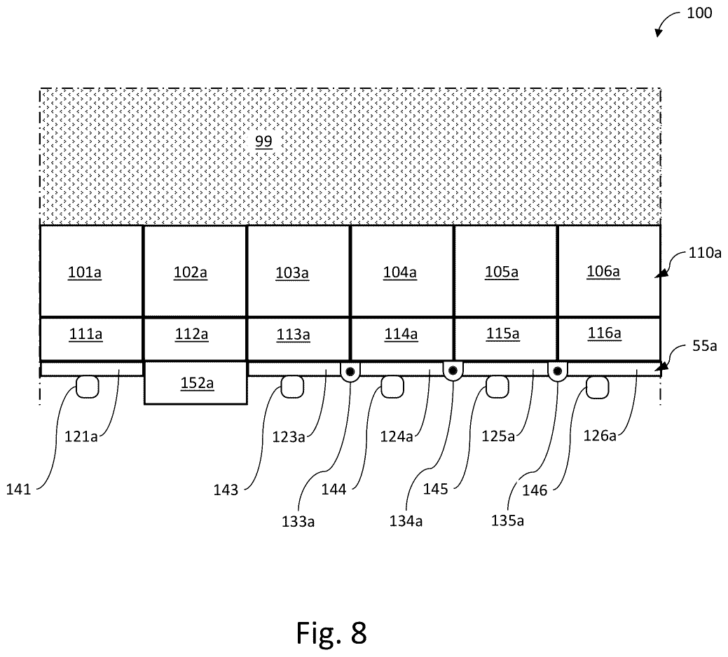

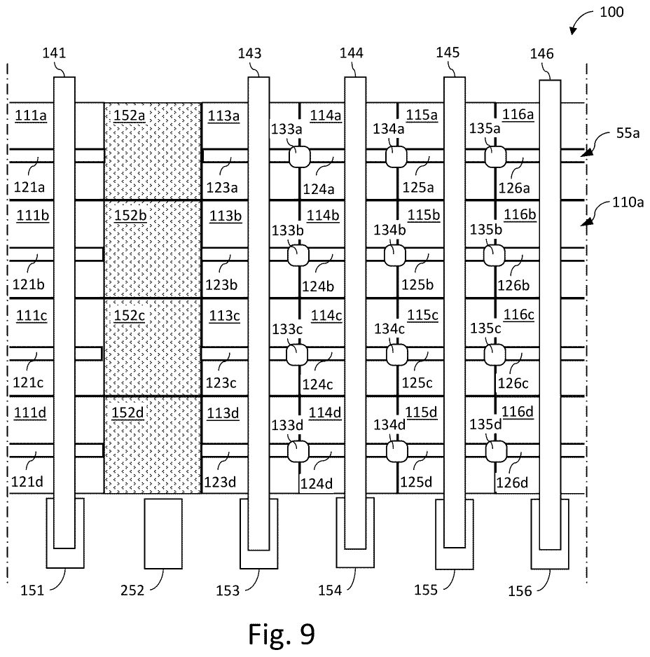

With reference to FIGS. 8 and 9, there is illustrated a portion 110a of perimeter wall 110 and a portion 55a of modular bracing network 105 at another state during an operation to add additional layers of overcoat refractory blocks. In the illustrated state, overcoat refractory blocks 152a, 152b, 152c, and 152d have been placed over overcoat refractory blocks 112a, 112b, 112c, and 112d and thereby added to the illustrated a portion 110a of perimeter wall 110. Such operation may be desirable at certain times during the life of perimeter wall 110, for example, when the underlying refractory blocks of perimeter wall 110 have experienced a certain amount of corrosion and thickness reduction. Additionally, in the illustrated state, temporary bracing (not illustrated) may be utilized to reinforce overcoat refractory blocks 152a, 152b, 152c, and 152d.

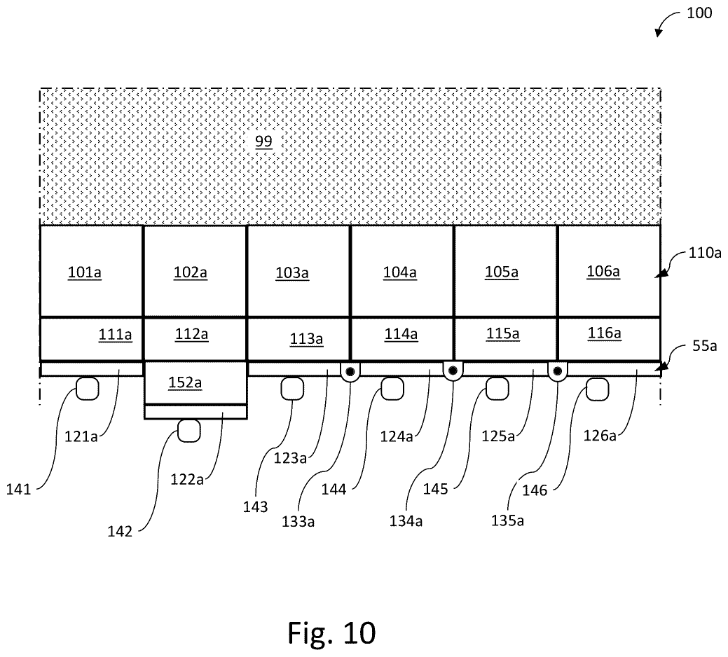

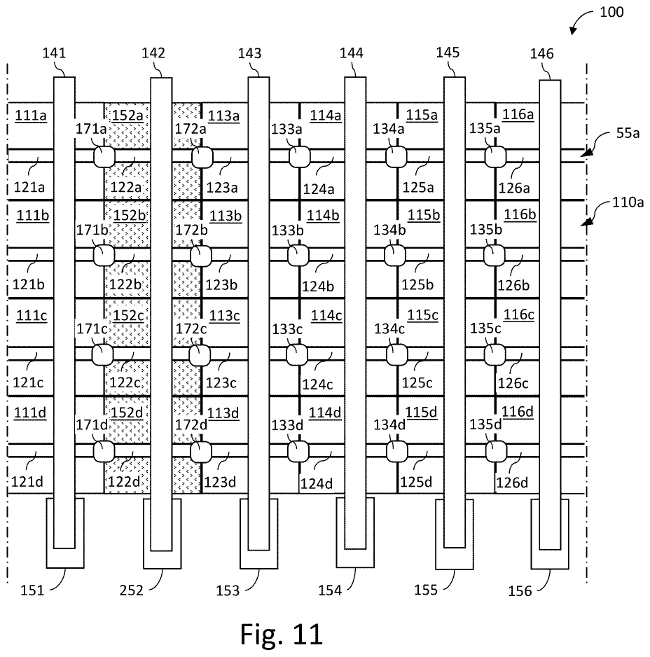

With reference to FIGS. 10 and 11, there is illustrated a portion 110a of perimeter wall 110 and a portion 55a of modular bracing network 105 at another state during an operation to add additional layers of overcoat refractory blocks. In the illustrated state, struts 122a, 122b, 122c, and 122d have been placed in supportive contact with overcoat refractory blocks 152a, 152b, 152c, and 152d, respectively. Furthermore, post 142 has been provided in and received by anchor 252 to provide reinforcement and bracing of perimeter wall 110 in the region of overcoat refractory blocks 152a, 152b, 152c, and 152d, underlying overcoat refractory blocks 112a, 112b, 112c, and 112d, and underlying refractory liner block 102a and the underlying refractory liner blocks underlying overcoat refractory blocks 112b, 112c, and 112d (not visible in the illustrated view).

From the illustrated state, the operation to add additional layers of overcoat refractory blocks may optionally proceed in several manners. In some instances, substantially similar operations as those described in connection with FIGS. 4-11 may be performed for other sections or portions of perimeter wall 110. For example, substantially similar operations may be performed for the section of perimeter wall 110 including overcoat refractory blocks 113a, 113b, 113c, and 113d, underlying refractory liner block 103a and the underlying refractory liner blocks underlying overcoat refractory blocks 113b, 113c, and 113d (not visible in the illustrated view), struts 123a, 123b, 123c, and 123d, fasteners 133a, 133b, 133c, and 133d, and post 143. Upon completion of sch operations, fasteners 132a, 132b, 132c, and 132d may be reintroduced to couple struts 122a, 122b, 122c, and 122d with struts 123a, 123b, 123c, and 123d, respectively. Subsequently, substantially similar operations may be performed for the other section of perimeter wall 110.

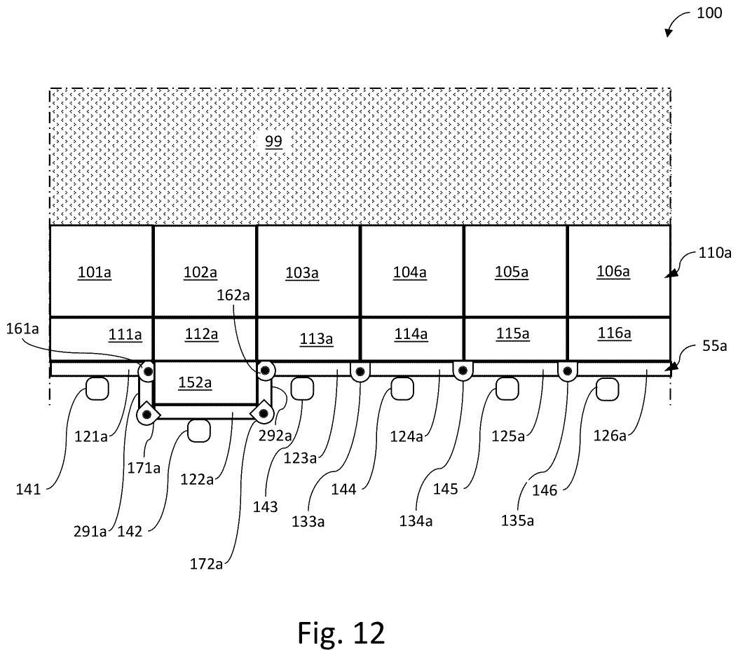

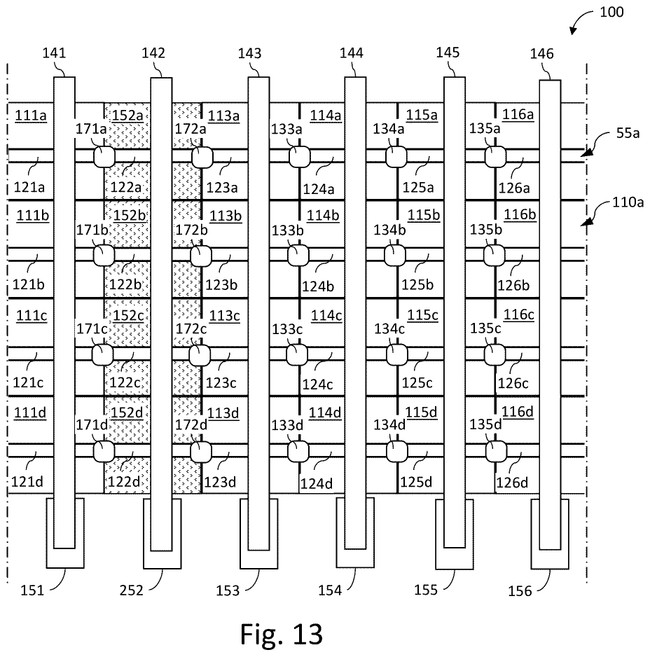

In some instances, it may be necessary to suspend the operation to add additional layers of overcoat refractory blocks, for example, due to limits on the time that system 100 can be taken offline to perform the operation. In such instances, additional semi-permanent components may be installed into modular bracing network 105, for example, as illustrated and described in connection with FIGS. 12 and 13.

With reference to FIGS. 12 and 13, there is illustrated a portion 110a of perimeter wall 110 and a portion 55a of modular bracing network 105 at another state during an operation to add additional layers of overcoat refractory blocks. In the illustrated state, semi-permanent strut 291a has been placed in contact with a side of overcoat refractory block 152a, coupled with strut 122a by semi-permanent fastener 171a, and coupled with strut 121a by semi-permanent fastener 161a. Additionally, semi-permanent strut 292a has been placed in contact with a side of overcoat refractory block 152a, coupled with strut 122a by semi-permanent fastener 172a, and coupled with strut 123a by semi-permanent fastener 162a. As depicted most clearly in FIG. 13, substantially similar couplings are provided for lower additional layers of overcoat refractory blocks 152b, 252c, 152d, by struts 122b, 122c, 122d, semi-permanent fasteners 171b, 171c, 171d, and semi-permanent fasteners 172b, 172c, 172d. From this state, substantially similar operations as those described in connection with FIGS. 4-11 and, optionally, those described in connection with FIGS. 12 and 13 may be performed for the section of perimeter wall 110. Such operations may be completed until additional layers of overcoat refractory blocks are added about the entirety of perimeter wall 110 which may include outlet throat region 109 of perimeter wall 110.

As illustrated by this detailed description, the present disclosure contemplates a number of embodiments including the following example embodiments.
Example embodiment 1. A furnace system for electric melting of glass, the furnace system comprising: a melting chamber bounded by a hearth and a perimeter wall comprising a first plurality of refractory liner blocks extending upward from the hearth and forming a perimeter of the melting chamber, and a plurality of overcoat refractory blocks facing the plurality of refractory liner blocks; a plurality of electrode islands comprising a plurality of electrodes extending through the hearth into the melting chamber; and a modular bracing network surrounding the plurality of overcoat refractory blocks and reinforcing the perimeter wall and including a plurality of struts and a plurality of fasteners coupling respective ones of the plurality of struts, each of the plurality of struts being individually removeable from the network by manipulation of a subset of the plurality of fasteners; the modular bracing network and the melting chamber being reconfigurable, while maintaining structural integrity of the perimeter wall to contain molten glass in the melting chamber, to a first modified configuration wherein a first set of the plurality of fasteners have been unfastened and a corresponding first set of the plurality of struts have been removed from the modular bracing network to provide a first set of exposed overcoat refractory blocks, and to a second modified configuration wherein a set of additional overcoat refractory blocks are placed in contact with the first set of exposed overcoat refractory blocks and a set of additional struts bracing the set of additional overcoat refractory blocks are coupled with the modular bracing network by respective fasteners.
Example embodiment 2 includes the features of example embodiment 1, wherein the modular bracing network comprises a plurality of posts received by and extending upward from a respective plurality of substrate anchors, the plurality of posts contacting respective ones of the plurality of struts.
Example embodiment 3 includes the features of example embodiment 2, wherein the modular bracing network comprises a second plurality of substrate anchors spaced apart from the plurality of substrate, the plurality of posts being selectably removeable from the respective plurality of substrate anchors and insertable into the second plurality of substrate anchors.
Example embodiment 4 includes the features of example embodiment 1, wherein each of the plurality of electrode islands comprises at least four electrodes.
Example embodiment 5 includes the features of example embodiment 1, wherein the system is configured and operable to provide a glass outlet flow of one of: 280 metric tons per day or greater, 300 metric tons per day or greater, and 320 metric tons per day or greater.
Example embodiment 6 includes the features of example embodiment 1, wherein the melting chamber comprises an area of 140 square meters or greater.
Example embodiment 7 includes the features of example embodiment 1, wherein the system is configured and operable to provide one of: a melting rate of 2.28 metric tons per square meter or greater.
Example embodiment 8 includes the features of example embodiment 1, wherein the melting chamber is configured with a rectangular geometry.
Example embodiment 9 includes the features of example embodiment 8, wherein a first set of four of the plurality of electrode islands are positioned in first region of the rectangular geometry and a second set of four of the plurality of electrode islands are positioned in in a second region of the rectangular geometry.
Example embodiment 10 includes the features of example embodiment 9 wherein each of the first set of four of the plurality of electrode islands comprises four electrodes and each of the second set of four of the plurality of electrode islands comprises four electrodes.
Example embodiment 11. A furnace system for electric melting of glass, the furnace system comprising: a melting chamber bounded by a hearth and a perimeter wall comprising a first plurality of refractory liner blocks extending upward from the hearth and forming a perimeter of the melting chamber, and a plurality of overcoat refractory blocks facing the plurality of refractory liner blocks; a plurality of electrode islands extending through the hearth into the melting chamber, each of the plurality of electrode islands comprising at least four electrodes.
Example embodiment 12 includes the features of example embodiment 11, wherein the system is configured and operable to provide a glass outlet flow of one of: 280 metric tons per day or greater, 300 metric tons per day or greater, and 320 metric tons per day or greater.
Example embodiment 13 includes the features of example embodiment 11, wherein the melting chamber comprises an area of 140 square meters or greater
Example embodiment 14 includes the features of example embodiment 11, wherein the system is configured and operable to provide one of: a melting rate of 2.28 metric tons per square meter or greater.
Example embodiment 15 includes the features of example embodiment 11, wherein the melting chamber is configured with a rectangular geometry.
Example embodiment 16 includes the features of example embodiment 15, wherein a first set of four of the plurality of electrode islands are positioned in first region of the rectangular geometry and a second set of four of the plurality of electrode islands are positioned in a second region of the rectangular geometry.
Example embodiment 17 includes the features of example embodiment 16, wherein each of the first set of four of the plurality of electrode islands comprises four electrodes and each of the second set of four of the plurality of electrode islands comprises four electrodes.
Example embodiment 18 includes the features of example embodiment 11, comprising: a modular bracing network surrounding the plurality of overcoat refractory blocks and reinforcing the perimeter wall and including a plurality of struts and a plurality of fasteners coupling respective ones of the plurality of struts, each of the plurality of struts being individually removeable from the network by manipulation of a subset of the plurality of fasteners.
Example embodiment 19 includes the features of example embodiment 18, wherein the modular bracing network comprises a plurality of posts received by and extending upward from a respective plurality of substrate anchors, the plurality of posts contacting respective ones of the plurality of struts.
Example embodiment 20 includes the features of example embodiment 19, wherein the modular bracing network comprises a second plurality of substrate anchors spaced apart from the plurality of substrate, the plurality of posts being selectably removeable from the respective plurality of substrate anchors and insertable into the second plurality of substrate anchors.

While example embodiments of the disclosure have been illustrated and described in detail in the drawings and foregoing description, the same is to be considered as illustrative and not restrictive in character, it being understood that only certain example embodiments have been shown and described and that all changes and modifications that come within the spirit of the claimed inventions are desired to be protected. The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise indicated. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language herein, is intended merely to better illuminate the invention and does not pose a limitation on the scope of the invention unless otherwise claimed. No language in the specification should be construed as indicating any non-claimed element as essential to the practice of the invention. When the language “at least a portion” and/or “a portion” is used the item can include a portion and/or the entire item unless specifically stated to the contrary. Furthermore, use of words such as preferable, preferably, preferred or more preferred utilized in the description above indicates that the feature so described may be more desirable, it nonetheless may not be necessary and embodiments lacking the same may be contemplated as within the scope of the invention, the scope being defined by the claims that follow.

What is claimed is:

1. A furnace system for electric melting of glass, the furnace system comprising:
a melting chamber bounded by a hearth and a perimeter wall comprising a first plurality of refractory liner blocks extending upward from the hearth and forming a perimeter of the melting chamber, and a plurality of overcoat refractory blocks facing the plurality of refractory liner blocks;
a plurality of electrode islands comprising a plurality of electrodes extending through the hearth into the melting chamber; and
a modular bracing network surrounding the plurality of overcoat refractory blocks and reinforcing the perimeter wall and including a plurality of struts and a plurality of fasteners coupling respective ones of the plurality of struts, each of the plurality of struts being individually removeable from the network by manipulation of a subset of the plurality of fasteners;
the modular bracing network and the melting chamber being reconfigurable, while maintaining structural integrity of the perimeter wall to contain molten glass in the melting chamber, to a first modified configuration wherein a first set of the plurality of fasteners have been unfastened and a corresponding first set of the plurality of struts have been removed from the modular bracing network to provide a first set of exposed overcoat refractory blocks, and to a second modified configuration wherein a set of additional overcoat refractory blocks are placed in contact with the first set of exposed overcoat refractory blocks and a set of additional struts bracing the set of additional overcoat refractory blocks are coupled with the modular bracing network by respective fasteners.

2. The system of claim 1, wherein the modular bracing network comprises a plurality of posts received by and extending upward from a respective plurality of substrate anchors, the plurality of posts contacting respective ones of the plurality of struts.

3. The system of claim 2, wherein the modular bracing network comprises a second plurality of substrate anchors spaced apart from the plurality of substrate, the plurality of posts being selectably removeable from the respective plurality of substrate anchors and insertable into the second plurality of substrate anchors.

4. The system of claim 1, wherein each of the plurality of electrode islands comprises at least four electrodes.

5. The system of claim 1, wherein the system is configured and operable to provide a glass outlet flow of one of: 280 metric tons per day or greater, 300 metric tons per day or greater, and 320 metric tons per day or greater.

6. The system of claim 1, wherein the melting chamber comprises an area of 140 square meters or greater.

7. The system of claim 1, wherein the system is configured and operable to provide one of: a melting rate of 2.28 metric tons per square meter or greater.

8. The system of claim 1, wherein the melting chamber is configured with a rectangular geometry.

9. The system of claim 8, wherein a first set of four of the plurality of electrode islands are positioned in first region of the rectangular geometry and a second set of four of the plurality of electrode islands are positioned in in a second region of the rectangular geometry.

10. The system of claim 9 wherein each of the first set of four of the plurality of electrode islands comprises four electrodes and each of the second set of four of the plurality of electrode islands comprises four electrodes.

11. A furnace system for electric melting of glass, the furnace system comprising:
a melting chamber bounded by a hearth and a perimeter wall comprising a first plurality of refractory liner blocks extending upward from the hearth and forming a perimeter of the melting chamber, and a plurality of overcoat refractory blocks facing the plurality of refractory liner blocks;
a plurality of electrode islands extending through the hearth into the melting chamber, each of the plurality of electrode islands comprising at least four electrodes.

12. The furnace system of claim 11, wherein the system is configured and operable to provide a glass outlet flow of one of: 280 metric tons per day or greater, 300 metric tons per day or greater, and 320 metric tons per day or greater.

13. The furnace system of claim 11, wherein the melting chamber comprises an area of 140 square meters or greater.

14. The furnace system of claim 11, wherein the system is configured and operable to provide one of: a melting rate of 2.28 metric tons per square meter or greater.

15. The furnace system of claim 11, wherein the melting chamber is configured with a rectangular geometry.

16. The furnace system of claim 15, wherein a first set of four of the plurality of electrode islands are positioned in first region of the rectangular geometry and a second set of four of the plurality of electrode islands are positioned in a second region of the rectangular geometry.

17. The furnace system of claim 16, wherein each of the first set of four of the plurality of electrode islands comprises four electrodes and each of the second set of four of the plurality of electrode islands comprises four electrodes.

18. The furnace system of claim 11, comprising: a modular bracing network surrounding the plurality of overcoat refractory blocks and reinforcing the perimeter wall and including a plurality of struts and a plurality of fasteners coupling respective ones of the plurality of struts, each of the plurality of struts being individually removeable from the network by manipulation of a subset of the plurality of fasteners.

19. The furnace system of claim 18, wherein the modular bracing network comprises a plurality of posts received by and extending upward from a respective plurality of substrate anchors, the plurality of posts contacting respective ones of the plurality of struts.

20. The furnace system of claim 19, wherein the modular bracing network comprises a second plurality of substrate anchors spaced apart from the plurality of substrate, the plurality of posts being selectably removeable from the respective plurality of substrate anchors and insertable into the second plurality of substrate anchors.
